(19) United States
(12) Patent Application Publication
(10) Pub. No.: US 2003/0159061 A1
(43) Pub. Date: Aug. 21, 2003

(54) Secure electronic monetary transaction system

(76) Inventor: Xavier Namy, Perthes en Gatinais (FR)

Correspondence Address: FITZPATRICK CELLA HARPER & SCINTO, 30 ROCKEFELLER PLAZA, NEW YORK, NY, 10112, US

(21) Appl. No.: 10/307,645

(22) Filed: Dec. 2, 2002

Related U.S. Application Data
(60) Provisional application No. 60/334,441, filed on Nov. 30, 2001.

(51) Int. Cl. G06F 17/60

(52) U.S. Cl. 713/200; 705/64

(57) ABSTRACT

A system for conducting a secure electronic monetary transaction over a network. This invention includes an electronic storage medium adapted to store financial data. A system participant is assigned to a portion of the electronic storage medium. The financial data reflects the amount of money available to the system participant assigned to the portion of the electronic storage medium. The network includes all of the portions of the electronic storage medium. A mobile communication terminal is provided to the system participant. The mobile communication terminal is equipped with a transmitter-receiver device to connect to the network, and is equipped with a user interface to allow the system participant to enter identification data to access the electronic storage medium assigned to the system participant and transaction data to conduct a transaction. A transaction module is adapted to process and store the identification and transaction data entered by the system participant at the mobile communication terminal and to verify the identity of the system participant and to perform a transaction.

### CROSS-REFERENCE TO RELATED APPLICATION

This application claims the benefit of U.S. Provisional Application No. 60/334,441 filed Nov. 30, 2001, which is hereby incorporated by reference.

### BACKGROUND OF THE INVENTION

1. Field of the Invention

The present invention relates to systems and methods for conducting secure electronic monetary transactions over a network, and more particularly to a method and system for enabling an owner of an account to keep his money secure, to have exclusive control over it and to have secure, real-time access to it anywhere in the world.

2. Related Art

Automated teller machines (ATMs) have revolutionized the banking and financial services industry by increasing the ability to provide financial services to the consumer. For example, in the past virtually all consumer transactions were conducted in person. Thus, consumer access was generally limited to the business hours of branch locations. With the advent of ATM and other financial networks, consumers may now access financial services virtually twenty-four hours a day, seven days a week. This results in increased convenience and efficiency both for the service provider and the consumer.

Despite these successes, ATM and other financial networks in use today are characterized by certain shortcomings which limit consumer access and provide a barrier to more widespread accessibility and use. For example, the ATMs in greatest use today are hard wired in a fixed location. This hard wiring is necessary to provide power for the terminal and to provide access to communication lines, such as telephone lines, over which data may be exchanged with the financial service provider. Security concerns also play a role in limiting ATMs to fixed locations.

As a result of the fixed location of such terminals, financial networks must take great care in distributing ATMs over a particular geographic region so as to maximize consumer access. However, with changing demographics, such distributions may become less advantageous. For example, a new shopping mall may open in a first location, increasing demand in that area, while another mall may close in a second location thereby decreasing demand in that location. Onetime or isolated events resulting in an unexpected influx of people to a particular area may also result in an overwhelming demand which cannot be met satisfactorily by an existing distribution of terminals.

Additionally, problems arise when people travel between foreign countries which utilize different forms of currency. This may commonly arise where agents of companies need to travel to foreign countries to conduct business transactions for their companies. There may be difficulty in accessing an account and conducting a monetary transaction without speaking the local language. There may also be difficulty finding a bank or terminal in which to conduct such transactions.

Another difficulty is the ability to receive an immediate confirmation and update on the status of an account in real time following completion of a monetary transaction to ensure that the transaction has been accomplished successfully.

Accordingly, there is a need for a financial transaction and information system which can overcome the aforementioned shortcomings. Specifically, there is a need to provide people with the ability to be in control of their money and to conduct monetary transactions anywhere in the world at any time. Also, there is a need to receive an immediate confirmation and update on the status of an account, in real time, following completion of a monetary transaction to ensure that a transaction has been accomplished successfully. Further, there is a need for transaction and information terminals which do not need to be directly connected by lines to a telephone network or power source network.

There is an additional need to provide the above-described features without compromising the security provided by existing systems and without introducing inordinate costs.

### SUMMARY OF THE INVENTION

Accordingly, it is an object of this invention to enable an owner of an account to keep his money safe, to have exclusive control over it, and to have safe, real-time access to it anywhere in the world

It is also an object of this invention to enable an owner of an account to conduct a monetary transaction anywhere in the world using a mobile terminal transaction.

It is another an object of this invention to ensure that money placed in an account, using such mobile access, is secure.

It is a further object of this invention to ensure that money in such an account is accessible in the currency of one's choice anywhere in the world.

One embodiment of the invention is directed to a system for conducting a secure electronic monetary transaction over a network. This embodiment of the invention includes an electronic storage medium adapted to store financial data. A system participant is assigned to a portion of the electronic storage medium. The financial data reflects the amount of money available to the system participant assigned to the portion of the electronic storage medium. The network includes all of the portions of the electronic storage medium. This embodiment also includes a mobile communication terminal which is provided to the system participant. The mobile communication terminal is equipped with a transmitter-receiver device to connect to the network, and is equipped with a user interface to allow the system participant to enter identification data to access the electronic storage medium assigned to the system participant and transaction data to conduct a transaction. This embodiment further includes a transaction module which is adapted to process and store the identification and transaction data entered by the system participant at the mobile communication terminal and to verify the identity of the system participant and to perform a transaction.

Another embodiment of the invention is directed to a method for conducting a secure electronic monetary transaction over a network. This embodiment of the invention includes the steps of assigning a system participant to a portion of an electronic storage medium and storing financial data in a portion of the electronic storage medium, where the financial data reflects the amount of money available to the system participant assigned to the portion of the electronic storage medium and wherein the network comprises all of the portions of the electronic storage medium. This embodiment of the invention also includes the steps of allowing the system participant to connect to the network, receiving from the system participant, identification data to access the portion of the electronic storage medium assigned to the system participant and transaction data to conduct a transaction, and processing the identification data and the transaction data entered by the system participant to verify the identity of the system participant and to perform a transaction.

Yet another embodiment of the invention is directed to a system for conducting a secure electronic monetary transaction over a network. This embodiment of the invention includes a means for assigning a system participant to a portion of an electronic storage medium and a means for storing financial data in a portion of the electronic storage medium. The financial data reflects the amount of money available to the system participant assigned to that portion of the electronic storage medium. The network includes all of the portions of the electronic storage medium. This embodiment of the invention also includes a means for allowing the system participant to connect to the network and a means for receiving identification data from the system participant to access the portion of the electronic storage medium assigned to that system participant and transaction data to conduct a transaction. This embodiment of the invention further includes a means for processing the identification data and the transaction data entered by the system participant to verify the identity of the system participant and to perform a transaction.

The invention will next be described in connection with certain exemplary embodiments; however, it should be clear to those skilled in the art that various modifications, additions and subtractions can be made without departing from the spirit or scope of the claims.

### BRIEF DESCRIPTION OF THE DRAWINGS

The invention will be more clearly understood by reference to the following detailed description of exemplary embodiments in conjunction with the accompanying drawings, in which:

FIG. 1 is a block diagram showing a preferred embodiment of a system for conducting a secure electronic monetary transaction over a network in accordance with the present invention.

FIG. 2 is a flowchart showing the opening of a safe in accordance with an embodiment of the present invention.

FIG. 3 is a flowchart showing the closing of a safe in accordance with an embodiment of the present invention.

FIG. 4 is a flowchart showing the blocking of a safe by its owner in accordance with an embodiment of the present invention.

FIG. 5 is a flowchart showing the blocking of a safe by at a major counter in accordance with an embodiment of the present invention.

FIG. 6 is a flowchart showing the unblocking of a safe in accordance with an embodiment of the present invention.

FIG. 7 is a flowchart showing a withdrawal in accordance with an embodiment of the present invention.

FIG. 8 is a flowchart showing a deposit in accordance with an embodiment of the present invention.

FIG. 9 is a flowchart showing a transfer in accordance with an embodiment of the present invention.

### DETAILED DESCRIPTION OF THE DRAWINGS

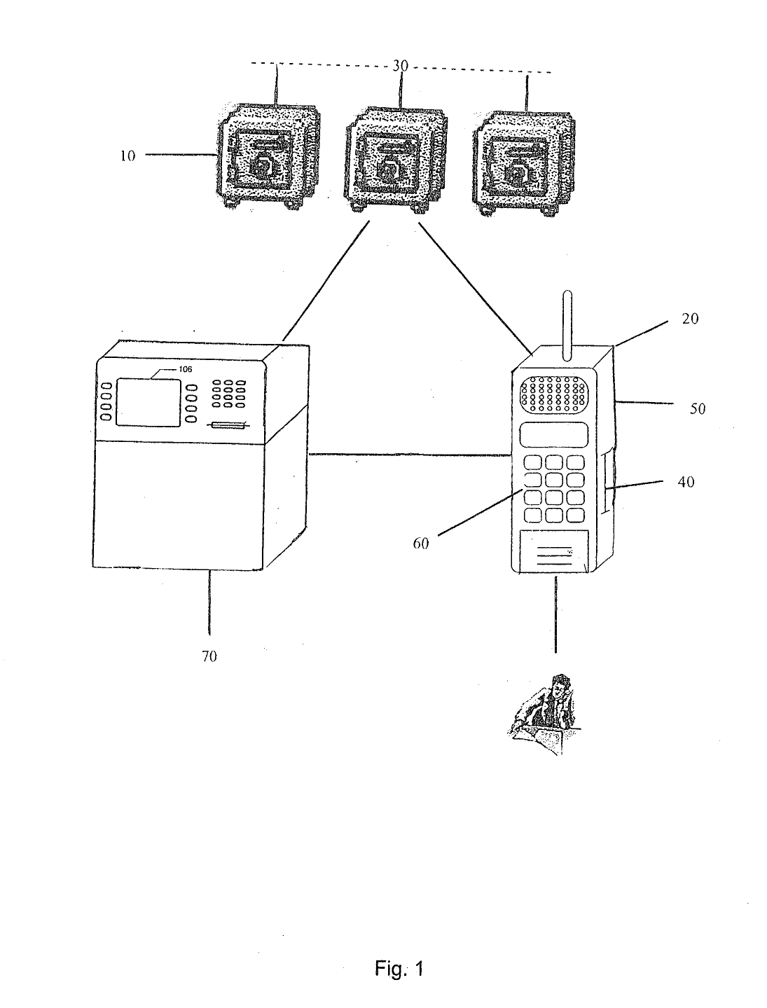

FIG. 1 is a block diagram showing a preferred embodiment of a system for conducting a secure electronic monetary transaction over a network in accordance with the present invention.

In this preferred embodiment, a holding company controls subsidiaries established in more than one country. Each subsidiary is an autonomous entity, within a specific country, that manages a club that is designed to offer its system participants, referred to as members, exclusive control over their money and secure, real-time access to their money anywhere in the world at any time. Each subsidiary assigns a portion of an electronic storage medium to each member and manages all monetary transactions conducted by its members. The subsidiary also manages all relations between its members and the members of other subsidiaries.

A member of the club may be an individual, more than one individual or a company or entity. Each member is assigned to a portion of an electronic storage medium, referred to and represented by a safe 10. Each member is the owner of the safe 10 to which the member is assigned and has full control of the content of that safe 10. A partner is generally a bank which belongs to the club and allows members of the club to physically deposit money to their safes 10 and to physically withdraw money from their safes 10, by transacting with a safe 10 assigned to the partner.

Each member is provided with a mobile communication terminal referred to as a key 20, which is owned by that member. A member may have several safes 10, in which case a key 20 is provided for each of the member's safes 10. The key 20 has two possible types of use: it can be used as a standard mobile telephone and it can be used to perform transactions either in the framework of the system of the invention, or for any other application requiring the verification of the instructing party's identification. For the present invention, its primary function is providing the member with access, using telecommunication operator networks, to that safe 10 to withdraw or inject money. The member's key 20 enables the member to securely perform a currency withdrawal from his safe 10, transfer money from that safe 10 to the safe 10 of another member of the club, or transfer money into his safe 10.

The key 20 comprises 2 subassemblies. The standard mobile terminal subassembly is equipped with a transmitter-receiver device 50 and allows wireless connection with a network 30. The network 30 includes a subsidiary and includes each member's safe 10 within a subsidiary. This subassembly varies according to various operational standards, such as GSM, UMTS, or SATELLITE. The member can use his key 20 to connect to the network 30 either by using a wireless network, or, when a wireless network is not available, by using the proximity liaison. The key 20 integrates a proximity transmission of the bluetooth type. The proximity liaison allows the key 20 to connect with a standard terminal which is already connected to a public network, such as a club terminal, PC, MAC, etc. or through direct wired connection with the network 30 using a modem or through the internet. In addition, the ability of the key 20 to access the network 30 enables its owner to use it as a standard mobile. The transactional subassembly allows the member to access and communicate with his safe 10, using any one of the above-mentioned methods which ensure transaction security within the framework of the club, or of any other application requiring identical security constraints. The transactional subassembly provides the member with a user interface 60 allowing the member to enter identification data to access the network 30, including the safe 10 assigned to the member and transaction data to perform a monetary transaction. These two subassemblies share common resources: power supply casing, keyboard screen, microphone, etc.

Contained within the key 20 is a transaction module 40. The transactional module 40 is adapted to process and store identification and transaction data entered by the member to verify the identity of the member and to perform the member's requested transactions. Before a key 20 is provided to a member, all of the member's identification data enabling the member's identification is stored on the transactional module 40. Matching the identification data entered at a member's key 20 and the identification data stored in an identification storage medium within the transaction module 40 is required to validate any transaction.

The transactional module 40 comprises several components with various functions, such as owner identification, transaction history, global positioning, encryption, and currency conversion. All of these functions are managed by a central processing unit within the transactional module 40.

Owner Identification

The transaction module 40 includes an identification storage medium which stores the identification data of the member. This identification data is stored indestructibly in the transaction module 40, and will be stored in the assigned member's safe 10. The key 20 integrates all of the items required, hence enabling the member to retrieve this information upon each transaction through the user interface 60. This identification data entered by the user will be compared with the identification data stored in the transaction module 40, by the system participant identifier. When matched, the member's identity will be verified and the link with the member's safe 10 will be established, automatically sending the message required for the member's safe 10 to authorize connection with the member's key 20. If the identification message meets the criteria required, and if the contents of the member's safe 10 allow it, the transaction entered by the member is authorized.

In another embodiment, the system participant identifier is a morphological identifier. When the key 20 is handed over to a member, the member's voice print, finger print, and/or iris print will be recorded. The key 20 integrates all of the items required (scanner or optical device type), hence enabling retrieval of the member's morphological identification data upon each transaction through the user interface 60. This identification data entered by the user will be compared with the identification data in the transaction module 40, by the morphological identifier. When matched, the member's identity will be verified and the link with the member's safe 10 will be established, automatically sending the message required for the member's safe 10 to authorize connection with the member's key 20.

Transaction History

The transaction module 40 also includes a transaction storage medium which stores the transaction data for all of the transactions involving the safe 10 assigned to the member. A member's transaction data includes all information relating to each transaction performed involving the safe 10 assigned to that member. Upon each transaction, all the information characterizing the transaction is recorded in the transaction storage medium. The contents of this transaction storage medium are accessible using the key's interface 60. The transaction data for each member will also be stored in each member's safe 10.

Global Positioning

The transactional module 40 will also integrate a global positioning system to determine and store in the transaction storage medium, the time and geographical position of the key 20 of each member involved in a transaction at the time of that transaction.

Encryption

The transaction module 40 is further adapted to encrypt all identification data and transaction data entered by the member in conducting a transaction. The member's key 20 and the member's safe 10 will each integrate an identical random access generator. Upon each transaction, the member's key 20 will send to the member's safe 10, the status of this random access generator, which must be identical to that in the member's safe 10 in order to ensure the transaction is possible. Any new transaction will trigger automatically a change in the status of each random access generator. Additional encryption of all of the information exchanged can be integrated.

Currency Conversion

The transaction module 40 further includes a currency converter which allows the member to convert the financial data stored in his safe 10 into an equivalent amount of financial data in one of a plurality of currencies, based on a current international monetary exchange rate, accessible from the subsidiary through the network 30.

A member may conduct several monetary transactions, including a withdrawal, deposit, or transfer, which are processed by the transaction module 40.

A member may also conduct transactions through use of a counter 70. A counter may be a physical location, such as a bank, or a stationary terminal, such as an ATM machine. One type of counter 70 is a major counter, which is a counter 70 belonging to the subsidiary. In addition to the opening, closing, blocking and unblocking operations that are reserved for major counters, they also allow members to withdraw, deposit, and transfer money. A second type of counter 70 is a partner counter, which is a counter 70 belonging to a partner, at which only a limited number of operations can be conducted. Withdrawal, deposit, and transfer operations can typically be conducted at partner counters but operations to open or close a safe 10 require the intervention of a major counter.

A member may withdraw an amount of money available in that member's safe 10. No member may withdraw an amount of money from another member's safe 10. The withdrawal of currency is realized: either at a counter 70, or by ordering, with the key, a transfer to another safe 10.

A member may also deposit an amount of money to a safe 10. A deposit may be made by any member to his own safe 10 or any other member's safe 10. The deposit of money by a member in his safe 10 may be achieved by a cash deposit at a counter, by a transfer from his bank account to the safe 10 owned by that partner who shall then order a transfer to its member's safe 10, or by transfer to a member's safe 10 from another member's safe 10.

A member may further transfer financial data reflecting an amount of physical money, from his safe 10 to two or more other members' safes 10.

The transaction module 40 is adapted to increment or decrement, in real time, the financial data stored in the member's safe 10 following completion of a monetary transaction involving the member's safe 10. Money transferred to a member's account shall be available immediately to the member for a monetary transaction.

The following figures are flowcharts demonstrating different monetary transactions that may be performed by a member in accordance with preferred embodiments of the invention.

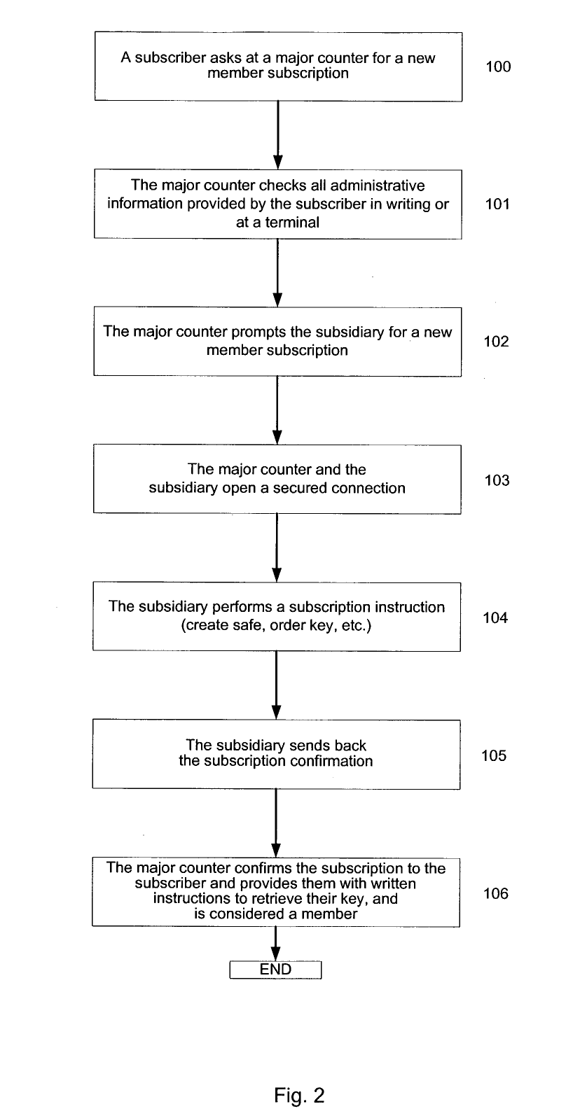

FIG. 2 is a flowchart showing the opening of a safe 10 in accordance with an embodiment of the present invention. Safe opening operations can only be conducted at major counters. The major counter must belong to the subsidiary in which the account is to be opened. A safe can be opened in any subsidiary. All safe opening operations shall be subject to the applicable laws in the country in which the subsidiary is installed. It is therefore possible for a person residing in the United States to open a safe in any other country where a subsidiary is located. Certain guarantees and information are required from the future member when he opens a safe, as well as the delivery of the key. A series of questions and answers used to identify the member for operations, such as safe blocking is also established at this stage.

At step 100, a subscriber asks at major counter for a new member subscription. At step 101, the major counter checks all administrative information provided by the subscriber in writing or at a terminal. At step 102, the major counter prompts the subsidiary for a new member subscription. At step 103, the major counter and the subsidiary open a secured connection. At step 104, the subsidiary performs a subscription instruction (create safe, order key, etc.). At step 105, the subsidiary sends back the subscription confirmation. At step 106, the major counter confirms the subscription to the subscriber and provides them with written instructions to retrieve their key, and the subscriber is considered a member.

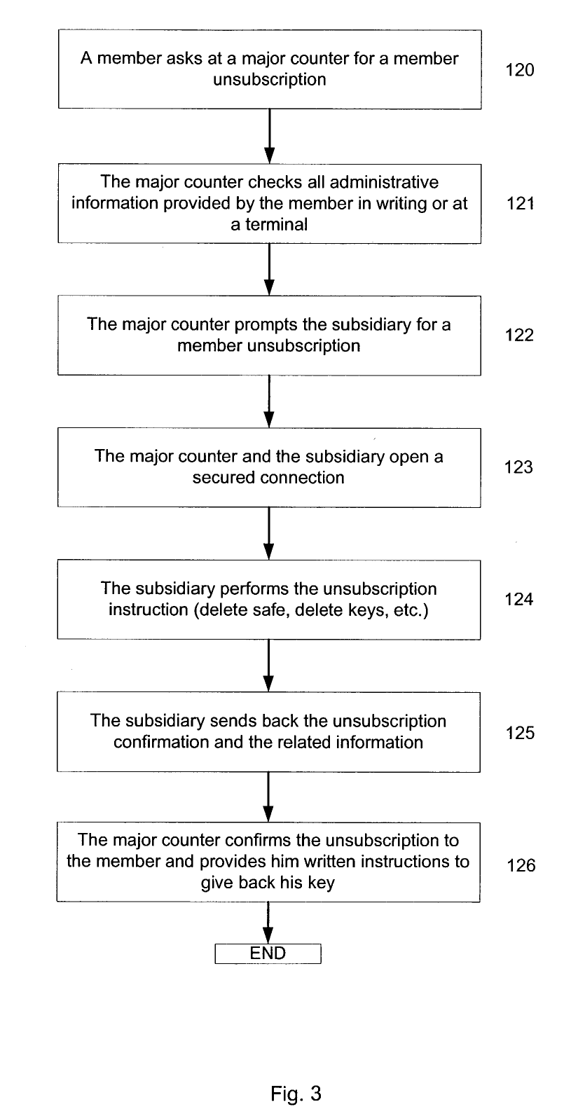

FIG. 3 is a flowchart showing the closing of a safe in accordance with an embodiment of the present invention. Safe-closing operations can only be conducted at major counters. The major counter must belong to the subsidiary in which the account is to be closed. Certain guarantees and information are required from a member when they close a safe, as well as the return of the key when applicable (if the client has no other club safes).

At step 120, a member asks at major counter for a member unsubscription. At step 121, the major counter checks all administrative information provided by the member in writing or at a terminal. At step 122, the major counter prompts the subsidiary for a member unsubscription. At step 123, the major counter and subsidiary open a secured connection. At step 124, the subsidiary performs the unsubscription instruction (delete safe, delete keys, etc.). At step 125, the subsidiary sends back the unsubscription confirmation. At step 126, the major counter confirms the unsubscription to the member and provides them with written instructions to give back their key.

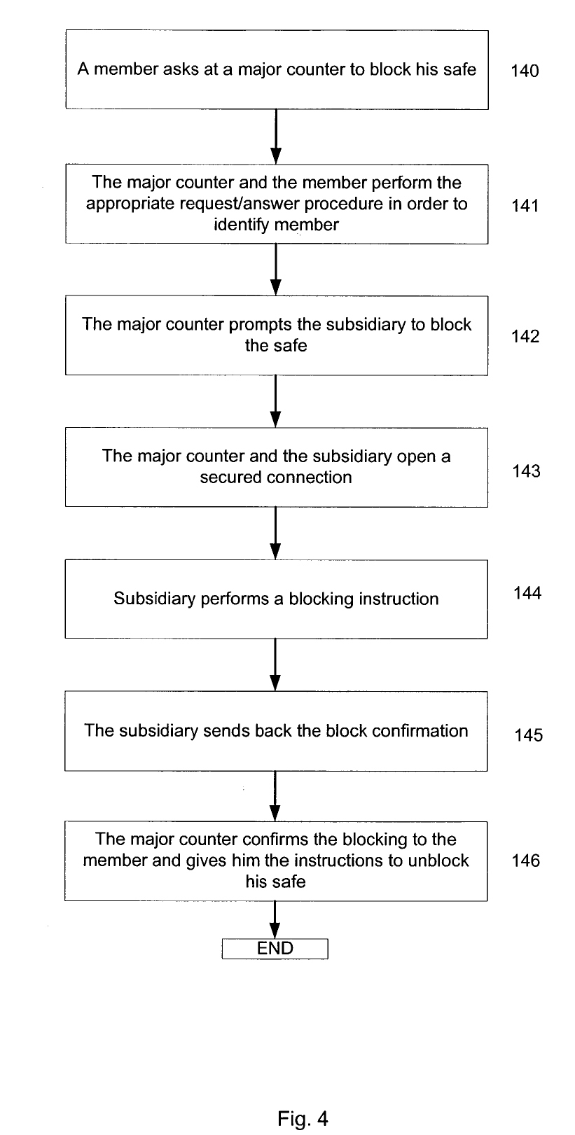

FIG. 4 is a flowchart showing the blocking of a safe by its owner in accordance with an embodiment of the present invention. A blocking instruction is an electronic operation performed by a subsidiary that prevents anyone from accessing a safe because a key has been lost or a fraud has been detected. Safes can only be blocked at the request of a major counter operator. The operator is a physical person with special rights, who is responsible for blocking the safe either because the monitoring system has detected an operational anomaly (fraud) or because the safe owner has requested it (lost key). In the latter case, a series of questions/answers is used to make a positive identification of the member requesting the blocking of the safe (these questions/answers are established when the safe is opened).

At step 140, a member asks at a major counter to block their safe. At step 141, the major counter and the member perform the appropriate request/answer procedure in order to identify member. At step 142, the major counter prompts the subsidiary to block the safe. At step 143, the major counter and the subsidiary open a secured connection. At step 144, the subsidiary performs a blocking instruction. At step 145, the subsidiary sends back the block confirmation. At step 146, the major counter confirms the blocking to member and gives him the instructions to unblock their safe later.

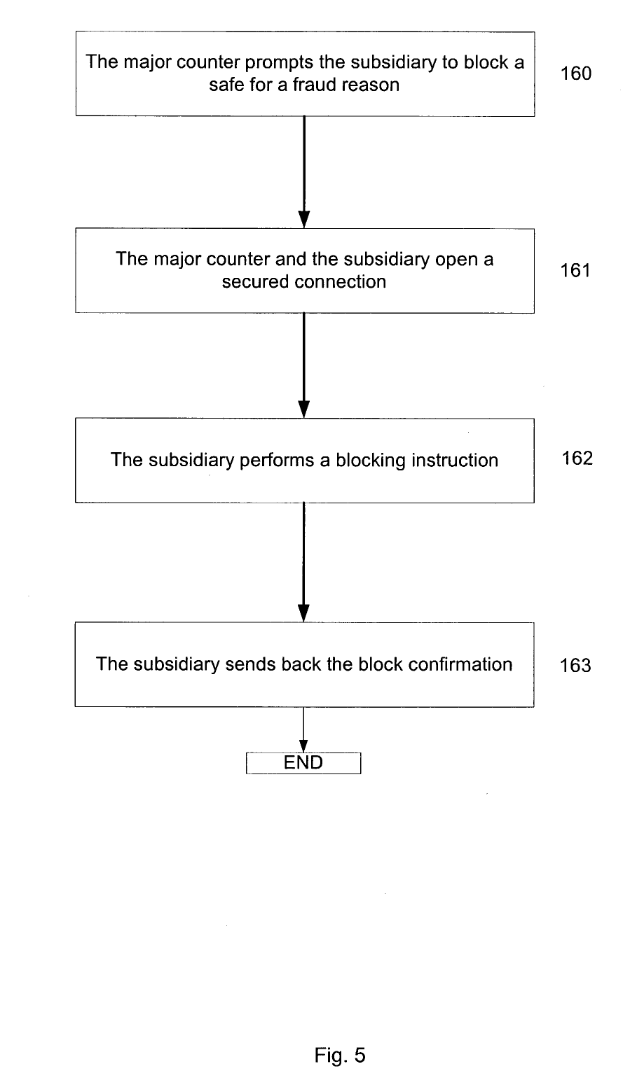

FIG. 5 is a flowchart showing the blocking of a safe by a major counter in accordance with an embodiment of the present invention.

At step 160, the major counter prompts the subsidiary to block a safe for a fraud reason. At step 161, the major counter and the subsidiary open a secured connection. At step 162, the subsidiary performs a blocking instruction. At step 163, the subsidiary sends back the block confirmation.

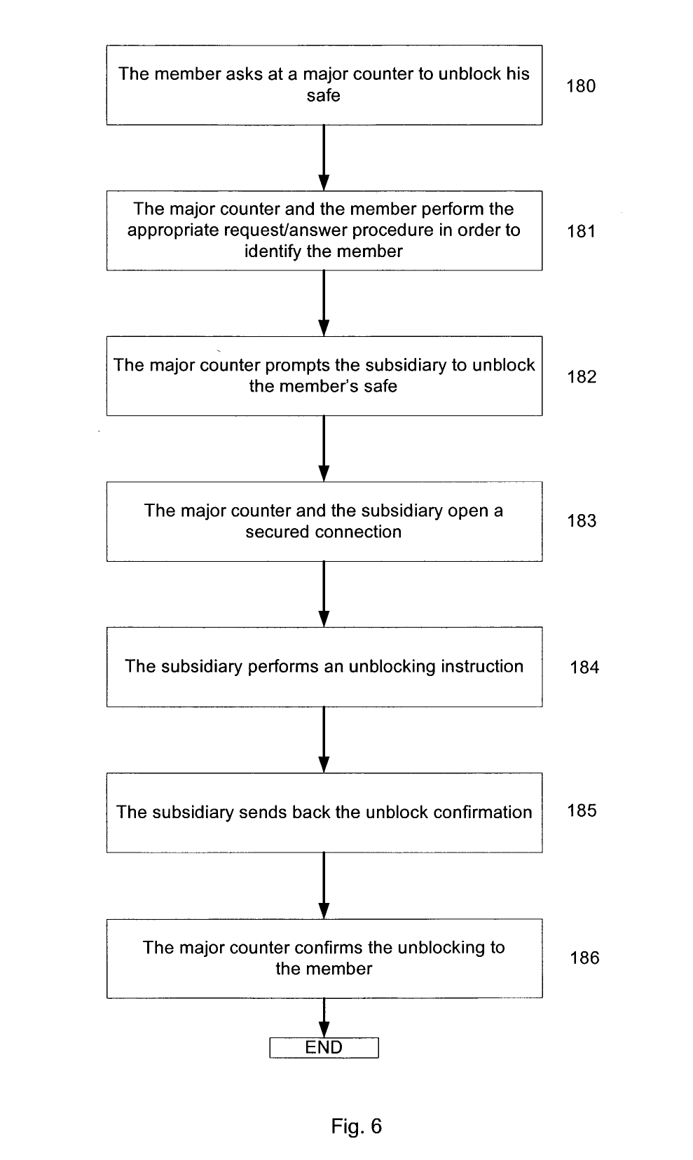

FIG. 6 is a flowchart showing the unblocking of a safe in accordance with an embodiment of the present invention. Safes can only be unblocked at the request of a major counter operator. The operator is a physical person with special rights, who is responsible for unblocking the safe on presentation of certain information (series of questions/answers).

At step 180, the member asks at a major counter to unblock his safe. At step 181, the major counter and the member perform the appropriate request/answer procedure in order to identify the member. At step 182, the major counter prompts the subsidiary to unblock the member's safe. At step 183, the major counter and the subsidiary open a secured connection. At step 184, the subsidiary performs an unblocking instruction. At step 185, the subsidiary sends back the unblock confirmation. At step 186, the major counter confirms the unblocking to the member.

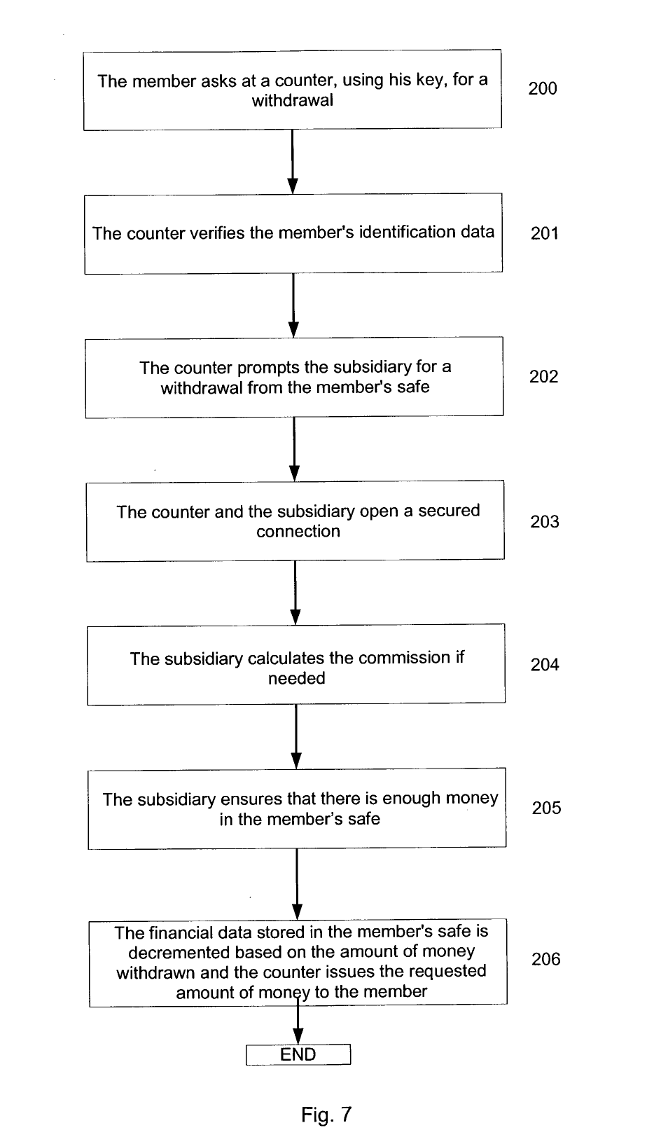

FIG. 7 is a flowchart showing a withdrawal in accordance with an embodiment of the present invention. Currencies can be withdrawn from a safe at a major counter or at a partner counter (bank, supermarket, ATM, etc). Withdrawals can be made in all countries where a subsidiary is established or in which a subsidiary has partners. A withdrawal operation involves: a member wishing to withdraw currencies at a partner counter, or a member wishing to withdraw currencies at a major counter. The first case corresponds to a transfer of money from a member's safe to a partner safe. The second case means simply debiting the member's safe with the money issuing directly from the subsidiary's funds.

At step 200, the member asks at a counter, using his key, for a withdrawal. At step 201, the counter verifies the member's identification data. At step 202, the counter prompts the subsidiary for a withdrawal from the member's safe. At step 203, the counter and the subsidiary open a secured connection. At step 204, the subsidiary calculates the commission if needed. At step 205, the subsidiary ensures that there is enough money in the member's safe. At step 206, the financial data stored in the member's safe is decremented based on the amount of money withdrawn and the counter issues the requested amount of money to the member.

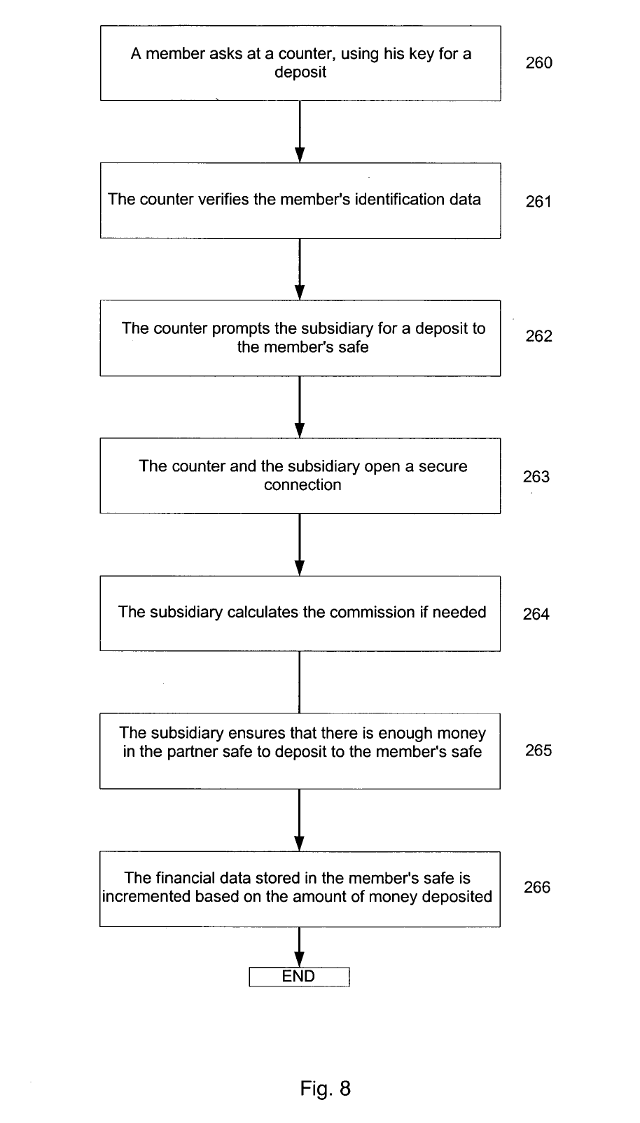

FIG. 8 is a flowchart showing a deposit in accordance with an embodiment of the present invention. Deposits to a safe can be conducted at a major counter or at a partner counter (bank, supermarket, ATM, etc). Deposits can be made in any currency (as far as possible). A deposit operation involves: a member wishing to deposit money at a partner's counter or a member wishing to deposit money at a major counter. The first case corresponds to a transfer of money from a partner safe to member safe. The second case is simply a matter of crediting the member's safe, with the money entering directly into the subsidiary's funds.

At step 260, a member asks at a counter, using his key for a deposit. At step 261, the counter verifies the member's identification data. At step 262, the counter prompts the subsidiary for a deposit to the member's safe. At step 263, the counter and the subsidiary open a secure connection. At step 264, the subsidiary calculates the commission if needed. At step 265, the subsidiary ensures that there is enough money in the partner safe to deposit to the member's safe. At step 266, the financial data stored in the member's safe is incremented based on the amount of money deposited.

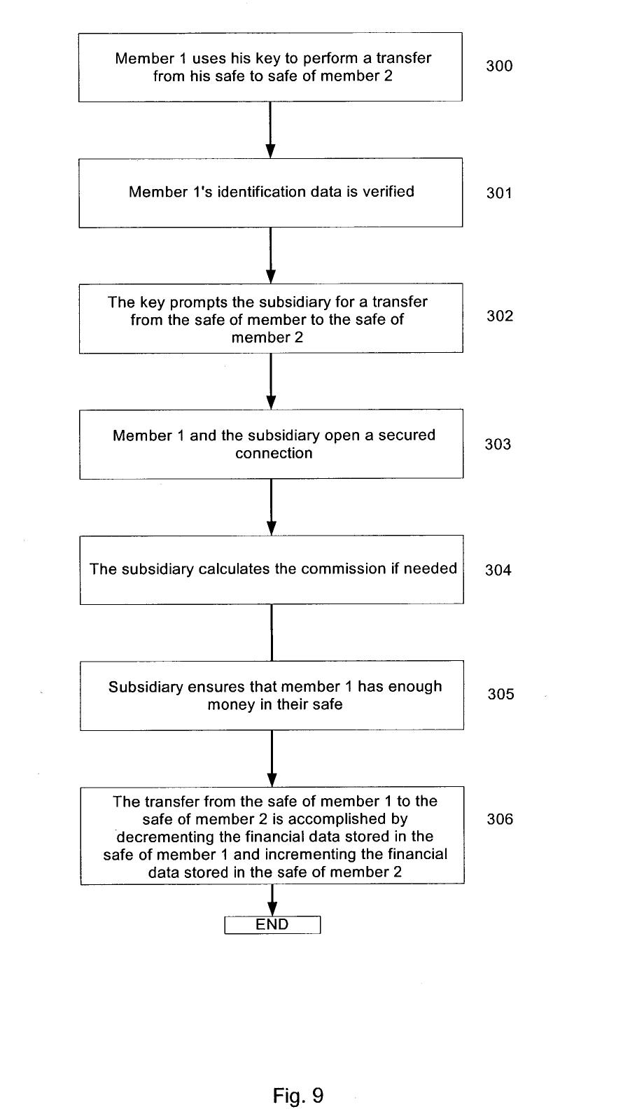

FIG. 9 is a flowchart showing a transfer in accordance with an embodiment of the present invention. Transfer operations from one safe to another safe can be conducted at major counters, at secondary counters (bank, supermarket, etc), or directly by performing a transaction with the member's key. Transfers can take place in any country where a subsidiary is established and can be conducted in any currency (as far as possible). A transfer operation involves a member wishing to make a transfer from his safe to another safe, either his own or that of another member.

In step 300, member 1 uses his key to perform a transfer from his safe to safe of member 2. At step 301, member 1's identification data is verified. At step 302, the key prompts the subsidiary for a transfer from the safe of member 1 to the safe of member 2. At step 303, member 1 and the subsidiary open a secured connection. At step 304, the subsidiary calculates the commission if needed. At step 305, subsidiary ensures that member 1 has enough money in his safe. At step 306, the transfer from the safe of member 1 to the safe of member 2 is accomplished by decrementing the financial data stored in the safe of member 1 and incrementing the financial data stored in the safe of member 2.

While the invention has been particularly shown and described with respect to preferred embodiments thereof, it will be understood by those skilled in the art that changes in form and details may be made therein without departing from the scope and spirit of the invention.

Having described the invention, what is claimed as new and secured by Letters Patent is:

What I claim is:

1. A system for conducting a secure electronic monetary transaction over a network, comprising:
an electronic storage medium adapted to store financial data, wherein a system participant is assigned to a portion of said electronic storage, wherein said financial data reflects an amount of physical money available to the system participant assigned to said portion of said electronic storage medium, and wherein said network comprises all said portions of said electronic storage medium;
a mobile communication terminal provided to the system participant, said mobile communication terminal being equipped with a transmitter-receiver device to connect to said network to, and being equipped with a user interface to allow the system participant to enter identification data to access said portion of said electronic storage medium assigned to the system participant and transaction data to conduct a transaction; and
a transaction module adapted to process and store said identification and transaction data entered by the system participant at said mobile communication terminal to verify the identity of the system participant and to perform said transaction.

2. The system of claim 1, wherein said mobile communication terminal is adapted to allow the system participant to wirelessly connect to said network.

3. The system of claim 1, wherein said mobile communication terminal is adapted to allow the system participant to connect to said network via a counter through use of a proximity liaison.

4. The system of claim 1, wherein said mobile communication terminal is adapted to allow the system participant to connect to said network through use of the internet.

5. The system of claim 1, wherein said transaction module further comprises an identification storage medium that stores said identification data of the system participant.

6. The system of claim 5, wherein said transaction module further comprises a system participant identifier that compares said identification data entered by the system participant at said mobile communication terminal with said identification data stored in said identification storage medium, to verify system participant's identity.

7. The system of claim 6, wherein said system participant identifier is a morphological identifier, and wherein said identification data entered by the system participant at said mobile communication terminal and stored in said identification storage medium is morphological identification data.

8. The system of claim 1, wherein said transaction module further comprises a transaction storage medium which stores said transaction data for all said transactions involving said portion of said electronic storage medium assigned to the system participant.

9. The system of claim 8, wherein said transaction module further comprises a global positioning system which determines and stores in said transaction storage medium, the time and geographical position of said mobile communication terminal of each system participant involved in said transaction at the time of said transaction.

10. The system of claim 1, wherein said transaction module further comprises a currency converter which allows the system participant to convert said financial data stored in said portion of said electronic storage medium assigned to the system participant into an equivalent amount of said financial data in one of a plurality of currencies.

11. The system of claim 1, wherein said transaction module is further adapted to increment or decrement, in real time, said financial data stored in said portion of said electronic storage medium assigned to the system participant following completion of said transaction involving said portion of said electronic storage medium assigned to the system participant.

12. The system of claim 1, wherein said transaction further comprises the withdrawal of an amount of money available in said portion of said electronic storage medium assigned to the system participant, wherein no system participant can withdraw an amount of money from said portion of said electronic storage medium assigned to another system participant.

13. The system of claim 1, wherein said transaction further comprises the deposit of an amount of money to said portion of said electronic storage medium assigned to the system participant, wherein said deposit may be made by any system participant.

14. The system of claim 1, wherein said transaction further comprises a transfer of said financial data reflecting an amount of money, between two or more of said portions of said electronic storage medium assigned to the system participants.

15. The system of claim 1, wherein said transaction further comprises the opening of said portion of said electronic storage medium assigned to the system participant.

16. The system of claim 1, wherein said monetary transaction further comprises the closing of said portion of said electronic storage medium assigned to the system participant.

17. The system of claim 1, wherein said transaction further comprises the blocking of said portion of said electronic storage medium assigned to the system participant.

18. The system of claim 1, wherein said transaction further comprises the unblocking of said portion of said electronic storage medium assigned to the system participant.

19. The system of claim 1, wherein said transaction module is further adapted to encrypt said identification data and said transaction data entered by the system participant in conducting said monetary transaction.

20. The system of claim 1, wherein said transaction is conducted by the system participants through use of a major counter.

21. The system of claim 1, wherein said transaction is conducted by the system participant through use of a partner counter.

22. A method for conducting a secure electronic monetary transaction over a network, comprising:
assigning a system participant to a portion of an electronic storage medium;
storing financial data in said portion of said electronic storage medium, wherein said financial data reflects the amount of money available to the system participant assigned to said portion of said electronic storage medium, and wherein said network comprises all of said portions of said electronic storage medium;
allowing the system participant to connect to said network;
receiving from the system participant, identification data to access said portion of said electronic storage medium assigned to the system participant, and transaction data to conduct a transaction; and
processing said identification data and said transaction data entered by the system participant to verify the identity of the system participant and to perform said transaction.

23. The method of claim 22, wherein said allowing step further comprises allowing the system participant to wirelessly connect to said network.

24. The method of claim 22, wherein said allowing step further comprises allowing the system participant to connect to said network via a counter through use of a proximity liaison.

25. The method of claim 22, wherein said allowing step further comprises allowing the system participant to connect to said network through use of the internet.

26. The method of claim 22, wherein said processing step further comprises storing said identification data of the system participant in an identification storage medium.

27. The method of claim 26, wherein said processing step further comprises comparing said identification data entered by the system participant with said identification data stored in said identification storage medium, and determining whether to authorize access to said portion of said electronic storage medium assigned to the system participant.

28. The method of claim 27, wherein said identification data entered by the system participant and stored in said identification storage medium is morphological identification data, and wherein comparing step further comprises comparing morphological identification data.

29. The method of claim 22, said processing step further comprises storing transaction data for all of said transactions involving said portion of said electronic storage medium assigned to the system participant.

30. The method of claim 29, wherein said processing step further comprises determining the time and geographical position of each system participant involved in said transaction at the time of all of said transactions and storing all of said times and said geographic positions.

31. The method of claim 22, wherein said processing step further comprises converting said financial data stored in said portion of electronic storage medium assigned to system participant into an equivalent amount of said financial data in one of a plurality of currencies.

32. The method of claim 22, wherein said processing step further comprises incrementing or decrementing, in real time, said financial data stored in said portion of said electronic storage medium assigned to the system participant following completion of said transaction involving said portion of said electronic storage medium assigned to the system participant.

33. The method of claim 22, wherein said processing step further comprises withdrawing an amount of money available in said portion of said electronic storage medium assigned to the system participant, wherein no system participant can withdraw an amount of money from said portion of said electronic storage medium assigned to another system participant.

34. The method of claim 22, wherein said processing step further comprises depositing an amount of money to said portion of said electronic storage medium assigned to the system participant, wherein a deposit may be made by any system participant.

35. The method of claim 22, wherein said processing step further comprises transferring an amount of said financial data reflecting an amount of money between two or more of said portions of said electronic storage medium assigned to the system participants.

36. The method of claim 22, wherein said processing step further comprises opening of said portion of said electronic storage medium assigned to the system participant.

37. The method of claim 22, wherein said processing step further comprises closing of said portion of said electronic storage medium assigned to the system participant.

38. The method of claim 22, wherein said processing step further comprises blocking of said portion of said electronic storage medium assigned to the system participant.

39. The method of claim 22, wherein processing step further comprises unblocking of said portion of said electronic storage medium assigned to the system participant.

40. The method of claim 22, wherein said processing step further comprises encrypting said identification and said transaction data entered by the system participant in conducting said transaction.

41. The method of claim 22, wherein said transaction is conducted by the system participant through use of a major counter.

42. The method of claim 22, wherein said transaction is conducted by the system participant through use of a partner counter.

43. A system for conducting a secure electronic monetary transaction over a network, comprising:
means for assigning a system participant to a portion of an electronic storage medium;
means for storing financial data in said portion of said electronic storage medium, wherein said financial data reflects the amount of money available to the system participant assigned to said portion of said electronic storage medium, and wherein said network comprises all of said portions of said electronic storage medium;
means for allowing the system participant to connect to said network;
means for receiving from the system participant, identification data to access said portion of said electronic storage medium assigned to the system participant, and transaction data to conduct a transaction; and
means for processing said identification and said transaction data entered by the system participant to verify the identity of the system participant and to perform said transaction.

44. The system of claim 43, further comprising means for allowing the system participant to wirelessly connect to said network.

45. The system of claim 43, further comprising means for allowing the system participant to connect to said network via a counter.

46. The system of claim 43, further comprising means for allowing the system participant to use the internet to connect to said network.

47. The system of claim 43, further comprising means for storing said identification data assigned to the system participant in an identification storage medium.

48. The system of claim 47, further comprising means for comparing said identification data entered by the system participant with said identification data stored in said identification storage medium and means for determining whether to authorize access to said portion of said electronic storage medium assigned to the system participant.

49. The system of claim 48, further comprising means for comparing morphological identification data, wherein said identification data entered by the system participant and stored in said identification storage medium is morphological identification data.

50. The system of claim 43, further comprising means for storing transaction data for all of said transactions involving said portion of said electronic storage medium assigned to the system participant.

51. The system of claim 50, further comprising means for determining the time and geographical position of each system participant involved in said transaction at the time of all of said transactions and means for storing all of said times and said geographic positions.

52. The system of claim 43, further comprising means for converting said financial data stored in said portion of electronic storage medium assigned to the system participant into an equivalent amount of said financial data in one of a plurality of currencies.

53. The system of claim 43, further comprising means for incrementing or decrementing, in real time, said financial data stored in said portion of said electronic storage medium assigned to the system participant following completion of said transaction involving the said portion of said electronic storage medium assigned to the system participant.

54. The system of claim 43, further comprising means for withdrawing an amount of money available in the said portion of said electronic storage medium assigned to the system participant, wherein no system participant can withdraw an amount of money from said portion of said electronic storage medium assigned to another system participant.

55. The system of claim 43, further comprising means for depositing an amount of money to the said portion of said electronic storage medium assigned to the system participant, wherein a deposit may be made by any system participant.

56. The system of claim 43, further comprising means for transferring of an amount of said financial data reflecting an amount of money between two or more said portions of said electronic storage medium assigned to the system participants.

57. The system of claim 43, further comprising means for opening of said portion of said electronic storage medium assigned to the system participant.

58. The system of claim 43, further comprising means for closing of said portion of said electronic storage medium assigned to the system participant.

59. The system of claim 43, further comprising means for blocking of said portion of said electronic storage medium assigned to the system participant.

60. The system of claim 43, further comprising means for unblocking of said portion of said electronic storage medium assigned to the system participant.

61. The system of claim 43, further comprising means for encrypting said identification data and said transaction data entered by the system participant in conducting said transaction.

62. The system of claim 43, further comprising means for conducting said transaction through use of major counter.

63. The system of claim 43, further comprising means for conducting said transaction through use of a partner counter.
